(19) United States
(12) Patent Application Publication
(10) Pub. No.: US 2018/0115983 A1
(43) Pub. Date: Apr. 26, 2018

(54) USER TERMINAL AND RADIO COMMUNICATION SYSTEM

(71) Applicant: NTT DOCOMO, INC., Tokyo (JP)

(72) Inventors: Hiroki Harada, Tokyo (JP); Kazuki Takeda, Tokyo (JP); Shimpei Yasukawa, Tokyo (JP); Satoshi Nagata, Tokyo (JP)

(73) Assignee: NTT DOCOMO, INC., Tokyo (JP)

(21) Appl. No.: 15/524,424

(22) PCT Filed: Oct. 9, 2015
(86) PCT No.: PCT/JP2015/078744

§ 371 Date: May 4, 2017

(30) Foreign Application Priority Data
Nov. 6, 2014 (JP) 2014-226126
Jan. 21, 2015 (JP) 2015-009785
Aug. 13, 2015 (JP) 2015-159943

(51) Int. Cl. H04W 72/12; H04W 16/14; H04W 72/04; H04W 24/10; H04W 88/06

(52) U.S. Cl. CPC H04W 72/1231; H04W 16/14; H04W 72/0406; H04W 72/08; H04W 24/10; H04W 88/06; H04W 72/1268

(57) ABSTRACT

The present invention is designed to adequately carry out uplink communication in unlicensed bands in a radio communication system (LAA) that runs LTE in unlicensed bands. The present invention provides a control section that controls the transmission of an uplink signal in a first frequency carrier by executing LBT (Listen Before Talk), and a transmitting/receiving section that receives a downlink signal that is transmitted from a radio base station in the first frequency carrier, and the control section executes LBT at an OFDM symbol timing in a subframe of the first frequency carrier, and, if the received power in the LBT period is equal to or lower than a predetermined threshold and the downlink signal is not detected, the control section detects that the subframe is not used to transmit the downlink signal, and controls the uplink signal to be transmitted in this subframe.

### TECHNIQUE FIELD

The present invention relates to a user terminal and a radio communication system in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). The specifications of LTE-advanced have been already drafted for the purpose of achieving further broadbandization and higher speeds beyond LTE, and, in addition, for example, a successor system of LTE—referred to as “FRA” (future radio access)—is under study.

In LTE of Rel. 8 to 12, the specifications have been drafted assuming exclusive operations in frequency bands that are licensed to operators—that is, licensed bands. For licensed bands, for example, 800 MHz, 2 GHz and/or 1.7 GHz have been in use.

LTE of Rel. 13 and later versions, which is under study, targets also operations in frequency bands where license is not required—that is, unlicensed bands. For unlicensed band, for example, 2.4 GHz, which is the same as in Wi-Fi, or the 5 GHz band and/or the like may be used. Although carrier aggregation (LAA: license-assisted access) between licensed bands and unlicensed bands is under study in Rel. 13 LTE, there is a possibility that, in the future, dual connectivity and stand-alone unlicensed-band may be studied as well.

In unlicensed bands, interference control functionality is likely to be necessary in order to allow co-presence with other operators' LTE, Wi-Fi, or different systems. In Wi-Fi, the function called “LBT” (Listen Before Talk) or “CCA” (Clear Channel Assessment) is implemented as an interference control function in the same frequency. In Japan and Europe, the LBT function is stipulated as mandatory in systems such as Wi-FI that is run in the 5 GHz unlicensed band.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”

### SUMMARY OF INVENTION

### Technical Problem

In order to allow uplink communication in unlicensed bands in a radio communication system (LAA) that runs LTE in unlicensed bands, there is a possibility that, before making uplink transmission, it is necessary to check whether the channel in which a signal is going to be transmitted is not already in use by other terminals and/or systems, as an LBT function, The method of allowing LTE uplink communication, incorporating LBT functions, has not been stipulated heretofore.

The present invention has been made in view of the above, and it is therefore an object of the present invention to provide a user terminal and a radio communication system, whereby uplink communication can be adequately carried out in unlicensed bands in a radio communication system (LAA) that runs LTE in unlicensed bands.

### Solution to Problem

The user terminal of the present invention has a control section that controls the transmission of an uplink signal in a first frequency carrier by executing LBT (Listen Before Talk), and a transmitting/receiving section that receives a downlink signal that is transmitted from a radio base station in the first frequency carrier, and, in this user terminal, the control section executes LBT at an OFDM symbol timing in a subframe of the first frequency carrier, and, if the received power in the LBT period is equal to or lower than a predetermined threshold and the downlink signal is not detected, the control section detects that the subframe is not used to transmit the downlink signal, and controls the uplink signal to be transmitted in this subframe.

### Advantageous Effects of Invention

According to the present invention, it is possible to adequately carry out uplink communication in unlicensed bands in a radio communication system (LAA) that runs LTE in unlicensed bands.

### BRIEF DESCRIPTION OF DRAWINGS

FIG. 1 is a diagram to explain a UL/DL subframe configuration in an unlicensed band, which is based on existing TDD-LTE;

FIG. 2 is a diagram to explain a UL/DL subframe configuration in an unlicensed band, according to a first embodiment;

FIG. 3 is a diagram to explain subframes in which a user terminal according to the first embodiment executes an LBT operation;

FIGS. 4 provide diagrams to explain resources in which a user terminal according to the first embodiment transmits control information;

FIG. 5 is a diagram to show an example of a schematic structure of a radio communication system according to the present embodiment;

FIG. 6 is a diagram to show an example of an overall structure of a radio base station according to the present embodiment;

FIG. 7 is a diagram to show an example of a functional structure of a radio base station according to the present embodiment;

FIG. 8 is a diagram to show an example of an overall structure of a user terminal according to the present embodiment;

FIG. 9 is a diagram to show an example of a functional structure of a user terminal according to the present embodiment;

FIG. 10 is a diagram to explain a UL/DL subframe configuration according to a second embodiment;

FIG. 11 provide diagrams to explain FBE-based UL/DL subframe configurations according to the second embodiment;

FIG. 12 provide diagrams to explain LBE-based UL/DL subframe configurations according to the second embodiment; and

FIG. 13 provide diagrams, each explaining an example of a UL transmission period in a user terminal according to the first embodiment.

### DESCRIPTION OF EMBODIMENTS

Now, an embodiment of the present invention will be described in detail below with reference to the accompanying drawings. Although an example case will be described below with the present embodiment where the frequency carrier to transmit uplink signals is an unlicensed band, the target to apply the present invention to is by no means limited to unlicensed bands. Although the present embodiment will be described assuming that a frequency carrier in which LBT is not configured is a licensed band and a frequency carrier in which LBT is configured is an unlicensed band, this is by no means limiting. That is, the present embodiment is applicable to any frequency carrier in which LBT is configured, regardless of whether this is a licensed band or an unlicensed band.

In a radio communication system (LAA) that runs LTE in unlicensed bands, it is sometimes the case that an LBT operation is obligatory. For example, in Japan and Europe, an LBT operation is required before transmission is started in an unlicensed band. Here, if the received signal intensity in the LBT period is higher than a predetermined threshold, the channel is judged to be in the busy state (LBT_{busy}). If the received signal intensity in the LBT period is lower than the predetermined threshold, the channel is judged to be in the idle state (LBT_{idle}).

When a user terminal performs uplink communication in LTE, the radio base station allocates radio resources to the user terminal, and, after this, the user terminal makes uplink transmission by using the allocated radio resources. The subframes where the radio resources are allocated and the subframes in which uplink signals are transmitted are a predetermined period of time apart. Considering that, in LAA, the radio base station allocates unlicensed band uplink resources to user terminals, a user terminal that is going to make transmission carries out an LBT operation shortly before the timing of uplink transmission, and, if the result yields LBT_{busy} the user terminal does not carry out uplink transmission in this resource. Consequently, although, in this case, neither downlink transmission nor uplink transmission takes place in this resource, there is still a possibility that, if this resource had been allocated to another user terminal's uplink transmission or to downlink communication from the radio base station, the user terminal or the radio base station, geographically apart and therefore having different channel states, would have been able to make communication based on the result of LBT. So, it is possible to say that, in this case, the resource was wasted.

In LTE, when the radio base station allocates a radio resource for uplink communication to a user terminal, a predetermined timing later, the radio base station tries to receive an uplink signal from the user terminal in this resource. If, in LAA, the radio base station fails to receive a signal in an unlicensed band resource in which uplink transmission or retransmission is made, the radio base station is unable to judge whether the signal was not transmitted due to the LBT result (LBT_{busy}) in the user terminal, or the user terminal transmitted the signal but the radio base station failed to receive the signal due to poor signal quality.

Although, in LAA, radio resources for uplink communication need to be secured in order to allow uplink communication in unlicensed bands, one possible method is to prepare UL subframes on a semi-static basis, by using TDD (time division duplex) UL/DL configurations. However, in this case, if a user terminal fails to communicate in a UL subframe due to the result of

LBT (LBT_{busy}) as mentioned earlier, or, on the other hand, the radio base station fails to communicate in a DL subframe due to the result of LBT, these resources may be regarded as a waste.

When DL and UL are multiplexed in the same carrier in TDD, although, normally, an operation to make the UL/DL configurations match via network synchronization is expected, in unlicensed bands, other operators or other RATs (radio access technology) are co-present in the same frequency, and synchronous operations with these different systems are not possible.

Uplink transmission in unlicensed bands may be carried out only in an opportunistic manner based on LBT results, and therefore the scheduling-based UL framework in existing LTE is likely to be unsuitable for LAA.

The ratio of UL/DL can be changed depending on traffic by using eIMTA (enhanced interference mitigation and traffic adaptation), which switches the UL/DL configuration in TDD radio frames, in 10-ms units, with L1 signaling. Nevertheless, whether or not this subframe can be used in UL/DL depends on the result of LBT. For example, eve when a given subframe is free of interference near the radio base station, if this subframe is a UL subframe, the radio base station cannot make downlink transmission in this subframe. If the radio base station makes downlink transmission in this subframe, user terminals cannot receive this signal.

It may be possible to report the results of LBT in user terminals to the radio base station by using licensed bands (explicit DTX reporting). By this means, the radio base station can learn the results of LBT in user terminals, and avoid executing unnecessary adaptive control or retransmission control. Still, the above-described problem of wasting resources due to semi-static uplink resource allocation cannot be solved.

In this way, the problem lies in how to efficiently allow uplink communication in LAA unlicensed bands.

In order to solve this problem, the present inventors have found out a configuration for efficiently allowing uplink communication in LAA unlicensed bands. To be more specific, the present inventors have found a configuration, which provides that unlicensed bands should be primarily used for downlink transmission, and which allows user terminals to carry out contention-based uplink transmission without scheduling from the radio base station.

### FIRST EXAMPLE

According to a first example, a user terminal can make uplink transmission in timings where LAA downlink transmission does not take place. A user terminal can autonomously judge whether a given subframe is an uplink subframe or a downlink subframe based on whether or not an LAA downlink signal is detected. Also, the contention in uplink transmission can be controlled on the radio base station side by, for example, controlling the number of user terminals that try making transmission, granting varying different priorities to the user terminals, and so on.

By this means, when the radio base station is unable to make downlink transmission due to the result of LBT (LBT_{busy}) on the radio base station side, on the user terminal side, a user terminal gains an opportunity to make uplink transmission, depending on its LBT result. That is, radio resources can be used flexibly, in UL/DL. Also, since uplink scheduling is not required, it may be possible to reduce the control signals. Furthermore, a user terminal can make uplink transmission in accordance with the situation of interference in its surroundings, based on LBT results, so that resources can be used effectively.

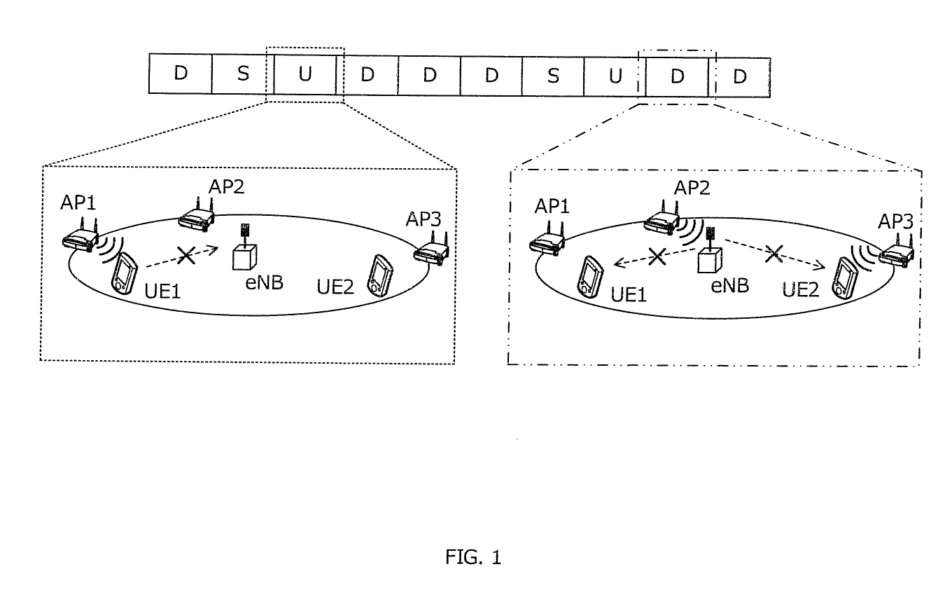

If existing TDD-LTE is used as a base, the UL/DL subframe configurations in the unlicensed band are determined in a fixed or in a half-fixed manner. In the example shown in FIG. 1, the third subframe is an uplink subframe, and the radio base station eNB allocates uplink transmission to a user terminal UE1. However, interference from a nearby communicating radio access point AP1 is detected (LBT_{busy}) in LBT in the user terminal UE1, and therefore the user terminal UE1 cannot make uplink transmission in this subframe. That is, this resource becomes a waste. In this example, however, the radio base station eNB or a user terminal UE2 would not have detected interference (LBT_{idle}) in this subframe, so that downlink transmission or uplink transmission could have been made in the unlicensed band.

In the example shown in FIG. 1, the ninth subframe is a downlink subframe. However, interference from a nearby communicating radio access point AP2 is detected (LBT_{busy}) in LBT in the radio base station eNB, and therefore the radio base station eNB cannot make downlink transmission in this subframe. That is, this resource becomes a waste. In this example, however, the user terminal UE1 would not have detected interference (LBT_{idle}) in this subframe, so that uplink transmission could have been made in the unlicensed band.

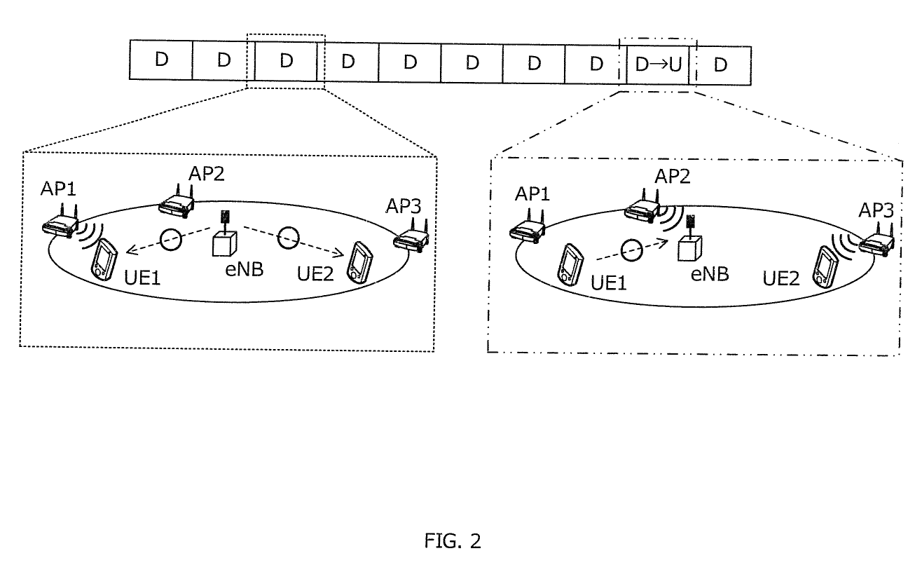

So, assume that, with the first example, all the subframes in the unlicensed band are basically used as downlink subframes (see FIG. 2). However, at the timings of subframes that are not used in LAA downlink transmission, user terminals can use the resources in uplink transmission.

In the example shown in FIG. 2, interference is not detected

(LBT_{idle}) in LBT in the radio base station eNB at the timing of the third subframe, so that the radio base station eNB makes downlink transmission in this subframe. The user terminals UE1 and UE2 detect and receive LAA downlink signals.

In the example shown in FIG. 2, the radio base station eNB does not make downlink transmission at the timing of the ninth subframe. Consequently, the user terminal UE1 does not detect an LAA downlink signal in this subframe timing. If the result of LBT in the subject terminal in this subframe timing yields LBT_{idle}, the user terminal UE1 can judge that uplink transmission can be made in this subframe.

Next, the identification of DL/UL subframes by user terminals will be described. A user terminal detects whether or not a given subframe is in use in LAA downlink transmission by using the OFDM symbol at the top of this subframe or by using the OFDM symbol at the end of the preceding subframe. This detection needs to be carried out after the LBT timing where whether or not downlink transmission is possible is decided in the radio base station.

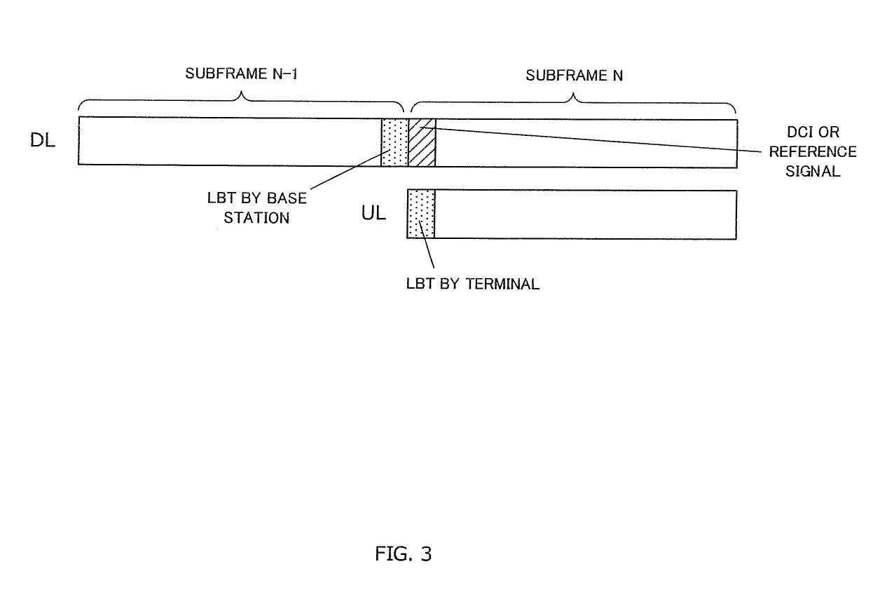

For example, as shown in FIG. 3, the radio base station may decide whether or not downlink transmission is possible in a subframe (N) by executing LBT in the OFDM symbol at the end of the preceding subframe (N−1), and a user terminal may decide whether or not uplink transmission is possible in the subframe (N) by executing LBT in the OFDM symbol at the top of this subframe (N). That is, when the radio base station makes downlink transmission in a subframe (N), the user terminal executes LBT in the timing this downlink transmission is carried out. When the user terminal executes LBT in the OFDM symbol at the top of the subframe (N), the user terminal may detect downlink control information (DCI) for the subject terminal, reference signals that are sent in downlink transmission, and so on.

When the received power in the LBT period is equal to or lower than a predetermined threshold and no LAA downlink signal is detected, the user terminal judges that this subframe is not used in LAA downlink transmission and that uplink transmission is possible in this subframe.

When the received power in the LBT period is equal to or lower than the predetermined threshold and a downlink signal (for example, the PCFICH (physical control format indicator channel) and so on) for another terminal is detected, the user terminal judges that this subframe is in use in LAA downlink transmission for another terminal and that uplink transmission is not possible in this subframe.

When the received power in the LBT period exceeds the predetermined threshold and downlink control information (DCI) for the subject terminal is detected, the user terminal judges that this subframe is in use in LAA downlink transmission, and performs downlink signal receiving operations in this subframe. The radio base station may transmit DCI either in the licensed band or in the unlicensed band.

In other cases—for example, when the received power in the LBT period exceeds a predetermined threshold but no LAA downlink signal is detected—the user terminal does not transmit or receive. This is, for example, the case where there is interference from other RATs.

After detecting an LAA signal from the reference signals and so on, the user terminal may perform a control signal demodulation operation, and, after that, perform a data receiving operation.

Next, uplink transmission operations by user terminals will be described. When the received power in an LBT period is equal to or lower than a predetermined threshold and no LAA downlink signal is detected, a user terminal can make uplink transmission in the subframe in the unlicensed band.

Whether or not each user terminal can use the uplink may be reported from the radio base station to user terminals in advance, by using RRC (radio resource control) signaling, MAC CEs (medium access control (MAC) control elements), L1 (layer 1) signaling, and so on. By this means, it is possible to narrow down the user terminals that might make uplink transmission. To be more specific, it is possible to report UL configuration (UL configuring) when RRC signaling is used, report UL activation when MAC CEs are used, and report a UL grant when L1 signaling is used.

In addition to each signaling given above, the radio base station may report a timer, which allows uplink transmission for a predetermined period of time following the reporting, to each user terminal. In this case, once the timer expires, a user terminal is no longer allowed to make uplink transmission even if LBT_{idle} is yielded. Also, the radio base station may also report a timer that disallows uplink transmission for a predetermined period of time following the reporting, to each user terminal.

It is equally possible to report varying backoff times from the radio base station to each user terminal, and allow the user terminals with shorter backoff times to make uplink transmission preferentially. Note that the backoff time refers to additional LBT time, and, a user terminal, to which a short backoff time is reported, can start transmission before a user terminal, to which a longer backoff time is reported, if LBT_{idle} is yielded. A user terminal, to which a long backoff time is reported, does not perform uplink communication if, during its LBT period, another user terminal starts communicating.

By setting up the configuration as to whether or not uplink transmission is possible, a timer and a backoff time in each user terminal, it is possible to avoid the situation where too many user terminals try to make uplink transmission, and where uplink transmission by each terminal only results in contention and the radio base station is unable to receive signals.

To the user terminals, the modulation and coding schemes (MCSs) or rank indicators (RIs) that are available for use may be reported in advance from the radio base station, by using RRC signaling, MAC CEs, L1 signaling and so on, in the licensed band or in the unlicensed band. That is, the radio base station can specify the MCS or RI to use in uplink transmission, in advance.

Alternatively, a user terminal may autonomously determine the MCS or RI to use. A user terminal may transmit, for example, information about an MCS or RI that is suitable for data transmission, to the radio base station, apart from the data symbols with which the MCS or RI which the user terminal determines autonomously is used. In this way, user terminals transmit MCS information and so on by using some fixed resources within one subframe, so that the radio base station can learn the MCS or RI to use in data demodulation, and so on.

User terminals may select the resources to use in uplink transmission, autonomously, including the bandwidth (the number of resource blocks). In this case, user terminals report the number of resource blocks to use for transmission, to the radio base station, together with MCS information and so on, in fixed resources.

Regarding the resources which user terminals use in uplink transmission, the network may configure subsets of resources in advance. For example, it is possible to configure four candidate resource sets, which are formed with twenty-five resource block units, in user terminals, by using RRC signaling, and allow each user terminal to choose one resource set to use in uplink transmission from among these candidate resource sets. Each user terminal may execute LBT per subset band, and select a subset that is suitable for use—for example, a subset where other terminals are not making transmission with shorter backoff time. As a plurality of subset patterns, it is equally possible to report, for example, a subset that is formed with twenty-five resource block units, and a subset that is formed with fifty resource block units, to user terminals, by using RRC signaling, and change the subset pattern to apply by using MAC or L1 signaling.

By allowing user terminals to select resources autonomously or by allowing the network to configure resources in advance, it is possible to flexibly change the subset configurations—that is, the number of users to multiplex, the rate of contention and so on—taking into consideration the level of congestion with uplink-transmitting terminals, or the condition of interference in the channel (the situation of other RATs such as Wi-Fi and so on).

Alternatively, user terminals may carry out uplink transmission in all bands in a frequency carrier, at all times. In uplink transmission, users may be multiplexed by way of code division multiplex (CDM). Alternatively, it is possible to combine with the above-noted case of frequency division multiplex (FDM) and carry out code division multiplex within a subband. By this means, even when a plurality of user terminals make uplink transmission in the same resources and create contention, communication is still possible. One possible interpretation of this is that the physical uplink control channel (PUCCH) transmission method is enhanced and the range of resource units to which code division multiplex is applied is widened.

Code division multiplex may be applied to only part of the symbols that report MCS and so on. By this means, the overall overhead can be reduced, compared to the case where MCS and so on are reported without applying code division multiplex thereto.

The radio base station may identify the terminal ID information (UE ID) and so on by way of blind detection, and identify the user terminals that are transmitting uplink signals. It is equally possible that the network reports the sequence indices to use to user terminals in advance, and, by this means, the radio base station may identify a user terminal by the blind detection of the UL RS sequence index. The radio base station may also identify a user terminal by using the ID that is reported in advance for masking in cyclic redundancy check (CRC).

When a user terminal transmits MCS information and so on separately, the UE ID may be included in this information and reported. The radio base station can identify the user terminals that are transmitting uplink signals, by using the UE IDs that are reported. In resources where MCS information and so on are reported, common scrambling may be used in part or all of the user terminals. The scrambling sequence index may be fixed, or may be reported to user terminals in advance through higher signaling. By this means, it is possible to keep the number of candidates for blind detection in the radio base station low.

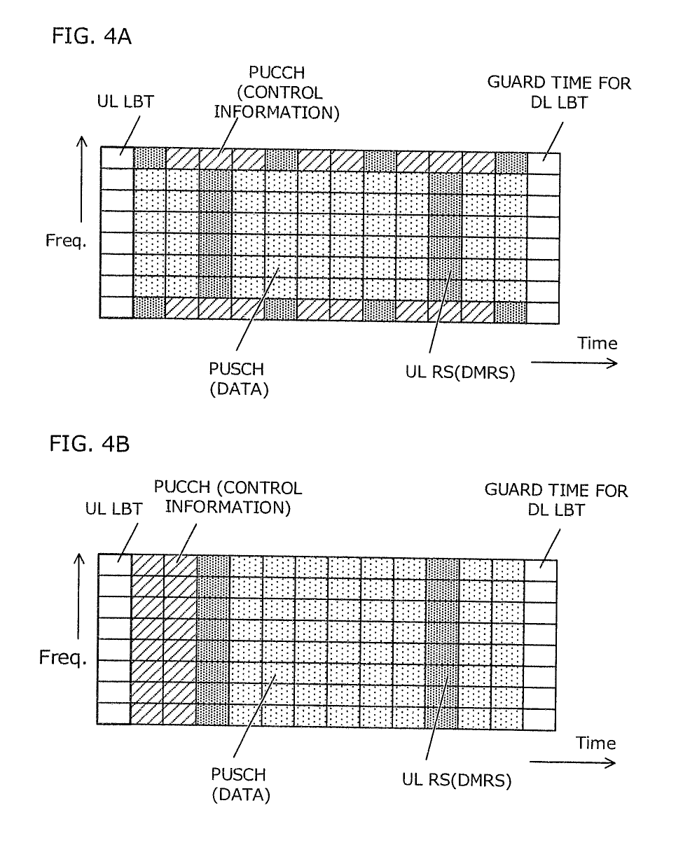

When a user terminal transmits information about the MCS that is used for the data symbols and so on in the unlicensed band, the PUCCH transmission method may be used (see FIG. 4A). The PUCCH transmission method refers to the use of specific resource blocks (for example, those of both edges) that are configured in advance, intra-subframe hopping, code division multiplex and so on. In this case, MCS information and so on are transmitted with data simultaneously, by using frequency division multiplex. One block that is shown in FIG. 4A does not strictly constitute one subcarrier or one resource block, and may indicate, for example, a plurality of resource block units.

The radio base station may report, in advance, the PUCCH resource index, the scrambling ID and so on for transmitting the MCS information and so on, to the user terminal. Alternatively, the user terminal may autonomously select the PUCCH resource index, the scrambling ID and so on for transmitting the MCS information and so on.

Alternatively, it is also possible to stipulate a new PUCCH format, and include the index of resources to use in data transmission, the scrambling ID and so on in MCS or RI information and so on. If the PUCCH portion can be blind-demodulated, the radio base station can learn which user terminal is making transmission by using which scrambling, MCS, rank and so on, in PUSCH resources where data is transmitted, so that demodulation is made easy.

Alternatively, a user terminal may transmit MCS information and so on by using part of the SC-FDMA (single carrier-frequency division multiple access) symbols in a subframe (see FIG. 4B). In this case, the MCS information and so on are time-division-multiplexed (TDM) with data and transmitted.

Referring to FIG. 4A and FIG. 4B, the resource block sets on both edges may be used as overhead. To be more specific, the resource block set on the left edge may be used in uplink LBT, and the resource block set on the right edge may be used as a guard time for downlink LBT. In uplink communication from user terminals to the radio base station, uplink reference signals (UL RSs), a physical uplink control channel (PUCCH) and a physical uplink shared channel (PUSCH) are used.

The uplink reference signals (UL RSs) may include the data demodulation reference signal (DMRS), or include a new reference signal for the uplink communication method of the present invention. The

PUCCH may be used to transmit control information. The PUCCH may be used to transmit, for example, the above-described MCS information and so on. The PUSCH is used to transmit uplink data. Note that, in PUSCH resources, data of multiple users may be multiplexed and transmitted, as mentioned earlier.

In the unlicensed band, it is possible to make part of the subframes fixed for use on the downlink or fixed for use on the uplink, and reports this to user terminals in advance, through higher layer signaling. For example, subframes that transmit measurement reference signals periodically may be made downlink-fixed. By this means, when part of the user terminals fail downlink detection and uplink transmission contention is created, the impact upon measurements can be prevented. Also, for example, subframes that are used for the physical random access channel (PRACH) may be made uplink-fixed. By this means, user terminals can have opportunities to make random access, on a regular basis.

Even in the event of LBT_{idle}, the radio base station may not make downlink transmission, purposefully. The radio base station can decide not to make downlink transmission based on the volume of uplink traffic in the licensed band, and so on. When LBT_{busy} is yielded, or when, even though LBT_{idle} is yielded, the radio base station does not make downlink transmission purposefully, the radio base station can perform receiving operations to prepare for receiving uplink signals.

<UL Transmission Control>

As described above, according to the first example, a user terminal carries out contention-based uplink transmission (for example, contention-based PUSCH) without scheduling from the radio base station. In this case, the user terminal performs an operation for detecting a reference signal (also referred to as the “initial signal,” “preamble,” etc.) that is transmitted from the radio base station, by executing listening (UL-LBT) at a predetermined timing.

If, by listening, the user terminal detects the reference signal transmitted from the radio base station, the user terminal understands that a predetermined period following the detection is a./ml9 DL transmission period (DL TTI). Meanwhile, if there is UL transmission traffic, the user terminal performs a reference signal (preamble) detection operation in the listening period, and, if no reference signal is detected, judges that UL transmission is possible. In this case, the user terminal can make UL transmission (contention-based UL transmission) without receiving a UL transmission command (for example, a UL grant) from the radio base station.

Also, when the user terminal fails to detect the reference signal upon listening, whether or not to allow autonomous UL transmission to this user terminal may be controlled by the radio base station. In this case, the radio base station can report whether or not autonomous UL transmission is applicable, to the user terminal, by using higher layer signaling, downlink control information and so on. Alternatively, the user terminal may be structured to perform autonomous UL transmission until receiving signaling for canceling autonomous UL transmission, from the radio base station.

When, in UL transmission, a user terminal performs listening in symbol units (or in time units shorter than symbols), the timings of transmission, which are determined based on the result of listening (LBT_{idle}), may not necessarily mark the boundaries between subframes. Depending on the result of listening (the timing to yield LBT_{idle}), cases might occur where the number of OFDM symbols that can be used for transmission in one subframe does not match the number of all OFDM symbols in the subframe (that is, the case where only part of the OFDM symbols can be used). In this case, it is preferable to make UL transmission by using part of the OFDM symbols, from the perspective of spectral efficiency and reducing the loss of transmission opportunities.

Therefore, when LBT_{idle} is yielded as a result of listening and UL transmission is going to be carried out, the user terminal starts UL transmission at the timing the listening is finished, and controls the UL transmission to be finished a predetermined period later. Note that, when random backoff is applied to listening, it is possible to see the timing where the random backoff period is finished as the timing listening is finished.

As for the predetermined period (the timing to finish UL transmission), this might come a predetermined period after the timing UL transmission is started, or may be determined based on a predetermined timing such as the next subframe boundary. For example, as a method of controlling the period of UL transmission based on the result of listening, it is possible to apply use floating TTIs, partial TTIs and super TTIs.

<Floating TTI Approach>

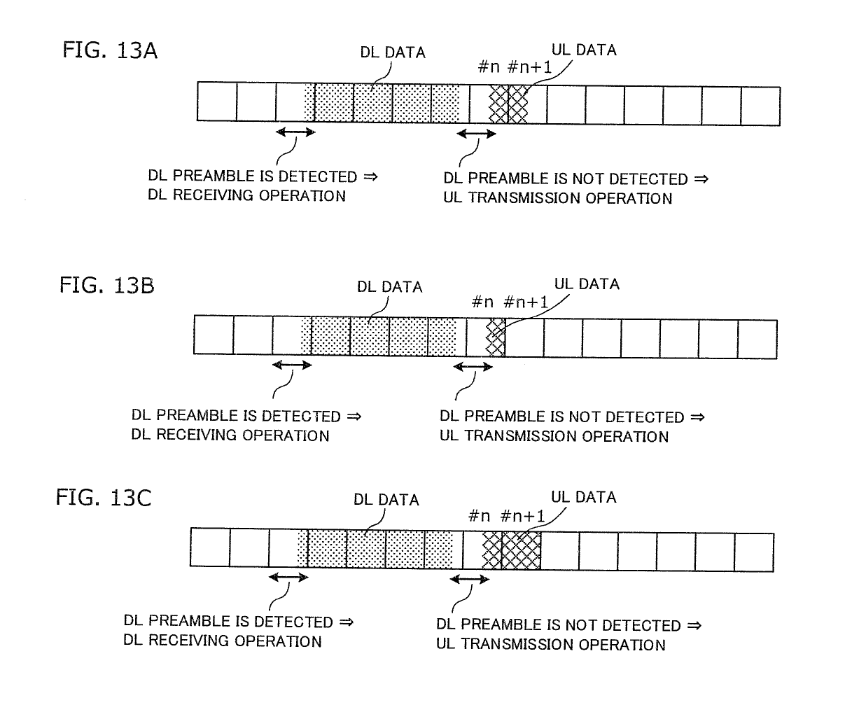

A user terminal can apply control so that UL transmission is started at the timing listening is finished (for example, in a predetermined symbol) and is finished 1 ms later. In this way, when floating TTIs are used, a signal to contain UL data (transport blocks) in TTI units (which are, for example, 1 ms long), from the transmission-starting timing based on the result of listening, is formed. When the user terminal starts transmission in the middle of a subframe n, the UL transmission can be controlled in TTI nits (for example, 1 ms), including the next subframe n+1. In this case, it is possible to carry out UL transmission by forming one TTI with part of the OFDM symbols in subframe n and part of the OFDM symbols in subframe n+1 (see FIG. 13A).

<Partial TTI Approach>

A user terminal can apply control so that UL transmission is started at the timing listening is finished (for example, in a predetermined symbol) and is finished within the subframe in which the UL transmission is started (that is, continues only up to the boundary with the next subframe). In this way, when partial TTIs are used, a signal to contain UL data (transport blocks) is formed by using part of the OFDM symbols within a single subframe. When the user terminal starts transmission in the middle of a subframe n based on the result of listening, UL data (for example, the PUSCH) and control signals (for example, the PUCCH) can be transmitted by using part of the OFDM symbols up to the boundary with the next subframe n+1 (see FIG. 13B).

<Super TTI Approach>

A user terminal can apply control so that UL transmission is started at the timing listening is finished (for example, in a predetermined symbol) and is finished at the timing the next subframe following the subframe in which the UL transmission is started is finished. In this way, when super TTIs are used, a signal to contain UL data (transport blocks) is formed by using OFDM symbols, including the whole of the next subframe, in addition to the subframe of the transmission-starting timing. When the user terminal starts transmission in the middle of a subframe n, UL transmission can be controlled by forming one TTI with part of the OFDM symbols in this subframe n and all of the OFDM symbols in the next subframe n+1 (see FIG. 13C).

Also, without scheduling from the radio base station, a user terminal may limit the UL signals/UL channels to use in contention-based uplink transmission to specific UL signals/UL channels. For example, a user terminal can apply control so that contention-based uplink transmission, which is based on listening, is made only in the PRACH, which is used in random access. Note that the UL signals/UL channels are by no means limited to the PRACH.

### SECOND EXAMPLE

With a second example, the UL/DL subframe configuration is determined flexibly, based on uplink grant commands. According to an uplink grant transmitted from the radio base station, a user terminal executes LBT for uplink transmission. The user terminal assumes that a subframe is used in downlink transmission, unless an uplink grant is received.

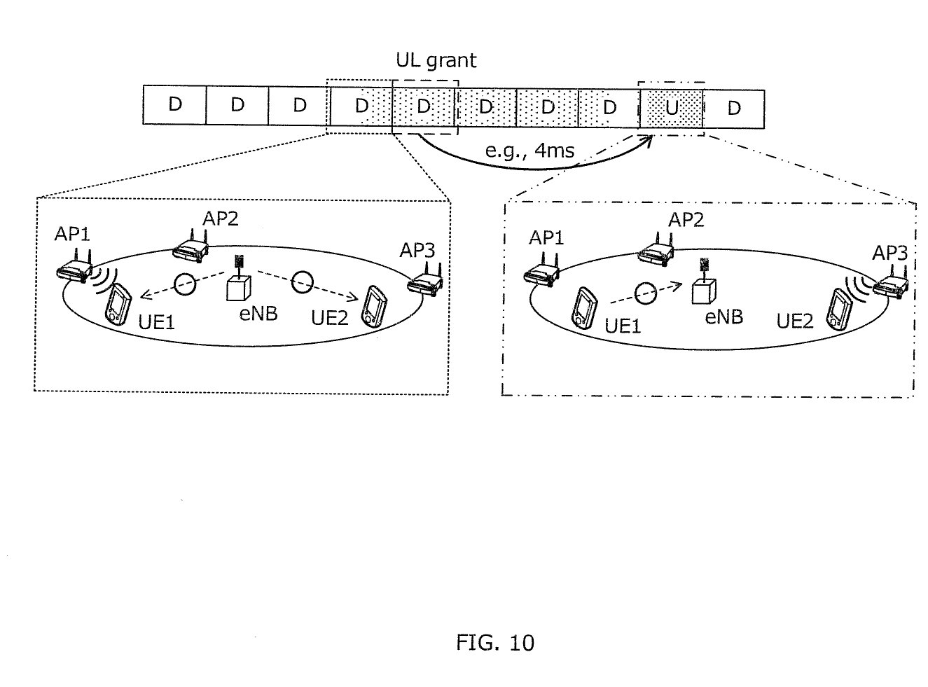

In the example shown in FIG. 10, the fourth subframe is a downlink subframe. If the radio base station eNB has downlink traffic and the result of LBT by the radio base station eNB is LBT_{idle}, this subframe can be used for downlink transmission. When the LBT result is LBT_{idle}, the radio base station can perform downlink transmission, in a predetermined period that follows (for example, 4 [ms]), without having to execute LBT again.

In the example shown in FIG. 10, the ninth subframe is an uplink subframe. When this is a subframe that is allocated as an uplink subframe by an uplink grant and the result of LBT by the user terminal UE is LTB_{idle}, the user terminal UE can use this subframe for uplink transmission.

The radio base station transmits uplink grant in the licensed band or in the unlicensed band. A user terminal, upon receiving an uplink grant, judges that the subframe that comes a predetermined period (for example, 4 [ms]) later is an uplink subframe, and makes uplink transmission based on the uplink grant. In the unlicensed band, the user terminal performs LBT prior to uplink transmission.

The “predetermined period” that comes in after an uplink grant is received may be determined in advance in the specification, or may be reported to user terminals through higher layer signaling such as SIB and/or RRC signaling. Also, this “predetermined period” may be included in DCI, and included in an uplink grant.

The radio base station performs uplink signal receiving operations in subframes which the radio base station has decided to use as uplink subframes by transmitting uplink grants.

With the second example, to provide an LBT mechanism on the downlink and the uplink, either FBE (Frame-Based Equipment) or LBE (Load-Based Equipment) may be used. FBE refers to an LBT mechanism that provides a fixed frame cycle, executes carrier sensing in part of the resources, and makes transmission if the channel is available for use, or waits until the next carrier sensing timing without making transmission if the channel cannot be used. LBE refers to an LBT mechanism that extends the carrier sensing duration when the result of carrier sensing shows that the channel cannot be used, and continues carrier sensing until the channel becomes available for use.

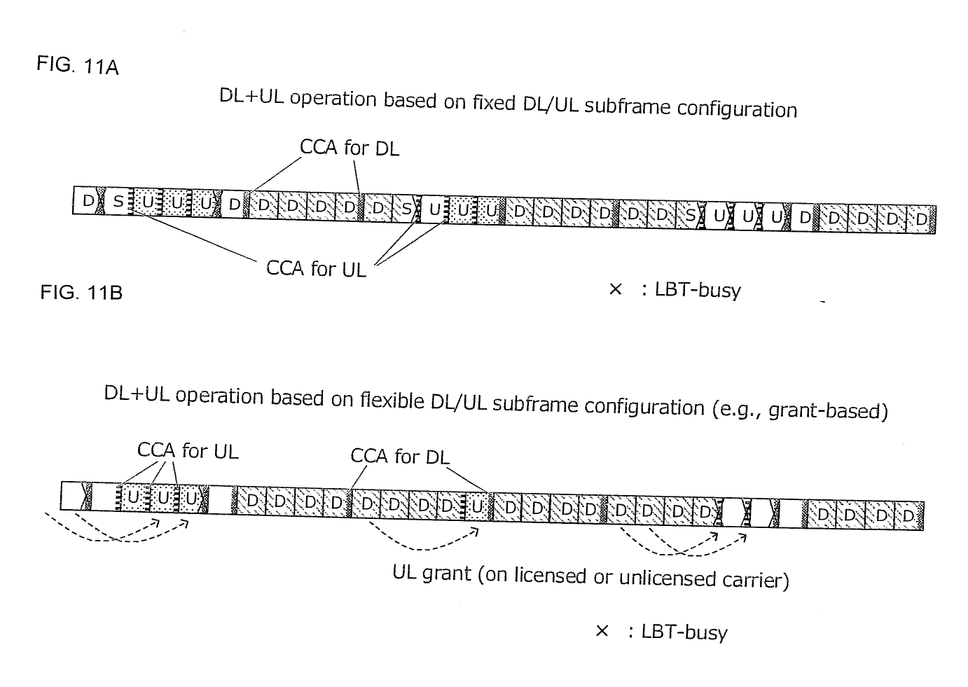

FIGS. 11 show downlink and uplink operations in an FBE-based frame configuration. In the examples shown in FIGS. 11, the radio base station executes LBT for the downlink in the last OFDM symbol in subframes that precede downlink subframes. A user terminal executes LBT for the uplink in the last OFDM symbol in subframes that precede uplink subframes. When the result of LBT is idle (LBT_{idle}), downlink transmission or uplink transmission is carried out.

FIG. 11A shows downlink and uplink operations based on a fixed UL/DL subframe configuration. FIG. 11B shows downlink and uplink operations based on a flexible UL/DL subframe configuration according to the second embodiment. The difference from FIG. 11A lies in that, in FIG. 11B, a user terminal executes LBT for the uplink according to uplink grants. In comparison to FIG. 11A, in the example shown in FIG. 11B, if the result of LBT for the downlink is idle (LBT_{idle}), the radio base station can make downlink transmission for the maximum period in which downlink transmission is possible without LBT (in FIG. 11B, a period of four subframes). Consequently, it is possible to say that resources are used more efficiently in the example shown in FIG. 11B.

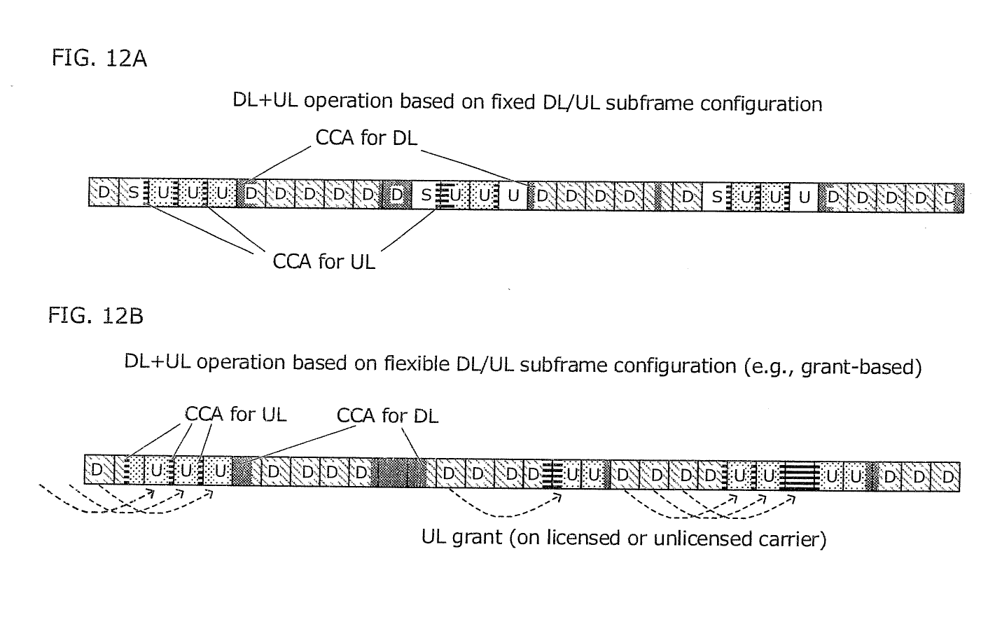

FIGS. 12 show downlink and uplink operations in an LBE-based frame configuration. In the examples shown in FIG. 12, transmission is started as soon as a channel is free, so that LBT is executed even in the middle of a subframe.

FIG. 12A shows downlink and uplink operations based on a fixed UL/DL subframe configuration. FIG. 12B shows downlink and uplink operations based on a flexible UL/DL subframe configuration according to the second embodiment. The difference from FIG. 12A lies in that, in FIG. 12B, a user terminal executes LBT for the uplink according to uplink grants. In comparison to FIG. 12A, in the example shown in FIG. 12B, if the result of LBT for the downlink is idle (LBT_{idle}), the radio base station can make downlink transmission for the maximum period in which downlink transmission is possible without LBT (in FIG. 12B, a period of four subframes). Consequently, it is possible to say that resources are used more efficiently in the example shown in FIG. 12B.

If LBE is used on the uplink, cases might occur where, depending on the result of LBT, transmission cannot be started in a subframe that is specified by an uplink grant. Therefore, a plurality of subframes may be bundled together and allocated as uplink subframes. For example, upon receiving an uplink grant, a user terminal may judge that the subframes in a certain period (for example, three subframes) starting a predetermined period later (for example, 4 [ms] later) are uplink subframes, and make uplink transmission based on the result of LBT.

According to the second example, the radio base station can make LBE-based downlink transmission more efficiently. If the result of LBT in the radio base station shows that a channel is busy (LBT_{busy}), the radio base station can extend the LBT period until it is confirmed that the channel is idle (LBT_{idle}). If the radio base station confirms that the channel is idle (LBT_{idle}), the radio base station can execute downlink transmission for the maximum burst period. All the subframes can be freely used for LBE-based downlink transmission.

This framework can cover both frame configurations that are directed to the downlink alone and frame configurations that are directed to both the downlink and the uplink. Unless the radio base station transmits uplink grants, a user terminal presumes a downlink-only frame configuration. The radio base station can configure uplink subframes, flexibly, by using uplink grants. By this means, high spectral efficiency can be achieved.

One problem that might arise here is cross-link interference. Basically, interference can be avoided by the LBT mechanism. The problem of hidden terminals can be solved by using mechanisms such as RTS/CTS, by cooperation with TPC, or by using subband sensing, random backoff and so on. Also, in the unlicensed band, the difference between the uplink and downlink power is not so significant.

Although configurations have been described with the first example and the second example in which a user terminal communicates with the radio base station by using a licensed band and an unlicensed band, the present invention is by no means limited to this. For example, a user terminal may communicate with the radio base station by using a frequency carrier in which LBT is configured and a frequency carrier in which LBT is not configured. For example, when a shared band—that is, a frequency that is shared between varying radio access systems (RATs)—is used, there is a possibility that even a licensed band requires LBT. In this case, by reporting this as a frequency carrier in which LBT is configured, to user terminals, it is still possible to execute adequate control, as with the above-described unlicensed band component carriers.

(Structure of Radio Communication System)

Now, the structure of the radio communication system according to the present embodiment will be described below. In this radio communication system, a radio communication method to perform the above-described unlicensed band uplink transmission operations in LAA is used.

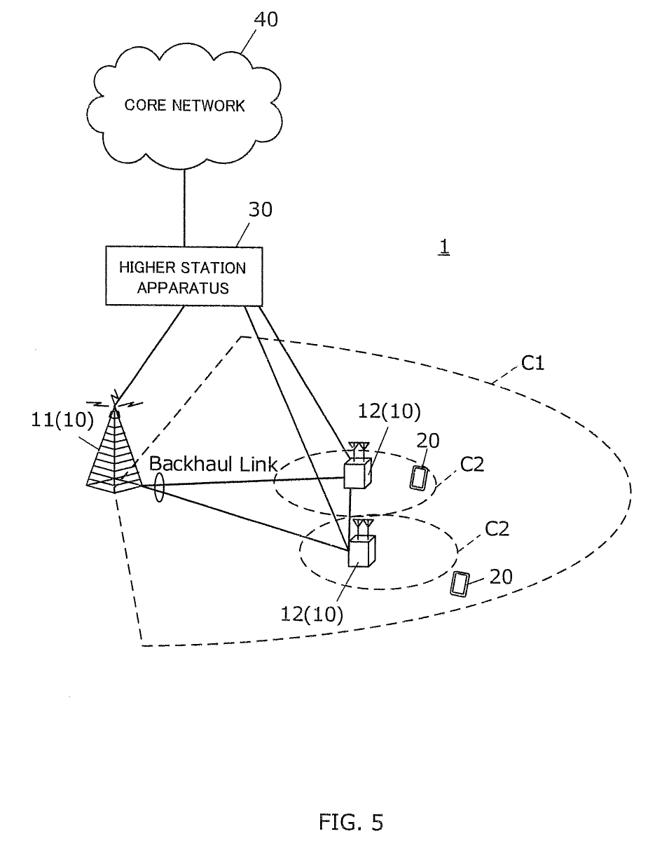

FIG. 5 is schematic structure diagram to show an example of a radio communication system according to the present embodiment. This radio communication system can adopt one or both of carrier aggregation (CA), which groups a plurality of fundamental frequency blocks (component carriers) into one, where the LTE system bandwidth constitutes one unit, and dual connectivity (DC). Also, this radio communication system provides a radio base station that can use unlicensed bands.

As shown in FIG. 5, a radio communication system I is comprised of a plurality of radio base stations 10 (11 and 12), and a plurality of user terminals 20 that are present within cells formed by each radio base station 10 and that are configured to be capable of communicating with each radio base station 10. The radio base stations 10 are each connected with a higher station apparatus 30. and are connected to a core network 40 via the higher station apparatus 30.

In FIG. 5, the radio base station 11 is, for example, a macro base station having a relatively wide coverage, and forms a macro cell C1. The radio base stations 12 are, for example, small base stations having local coverages, and form small cells C2. Note that the number of radio base stations 11 and 12 is not limited to that shown in FIG. 5.

For example, a mode may be possible in which the macro cell C1 is used in a licensed band and the small cells C2 are used in unlicensed bands. Also, a mode may be also possible in which part of the small cells C2 is used in a licensed band and the rest of the small cells C2 are used in unlicensed bands. The radio base stations 11 and 12 are connected with each other via an inter-base station interface (for example, optical fiber, the X2 interface, etc.).

The user terminals 20 can connect with both the radio base station 11 and the radio base stations 12. The user terminals 20 may use the macro cell C1 and the small cells C2, which use different frequencies, at the same time, by way of carrier aggregation or dual connectivity. For example, it is possible to transmit assist information (for example, the DL signal configuration) related to a radio base station 12 that uses an unlicensed band, from the radio base station 11 that uses a licensed band, to the user terminals 20. Also, a structure may be employed here in which, when carrier aggregation is used between a licensed band and an unlicensed band, one radio base station (for example, the radio base station 11) controls the scheduling of licensed band cells and unlicensed band cells.

The user terminals 20 may be structured to connect with radio base stations 12, without connecting with the radio base station 11. For example, a radio base station 12 to use an unlicensed band may be structured to connect with a user terminal 20 in stand-alone. In this case, the radio base station 12 controls the scheduling of unlicensed band cells.

The higher station apparatus 30 may be, for example, an access gateway apparatus, a radio network controller (RNC), a mobility management entity (MME) and so on, but is by no means limited to these.

In the radio communication system 1, a downlink shared channel (PDSCH: Physical Downlink Shared CHannel), which is used by each user terminal 20 on a shared basis, a downlink control channel (PDCCH (Physical Downlink Control CHannel), EPDCCH (Enhanced Physical Downlink Control CHannel), etc.), a broadcast channel (PBCH) and so on are used as downlink channels. User data, higher layer control information and predetermined SIBs (System Information Blocks) are communicated in the PDSCH. Downlink control information (DCI) is communicated using the PDCCH and/or the EPDCCH.

Also, in the radio communication system 1, an uplink shared channel (PUSCH: Physical Uplink Shared CHannel), which is used by each user terminal 20 on a shared basis, an uplink control channel (PUCCH: Physical Uplink Control CHannel) and so on are used as uplink channels. User data and higher layer control information are communicated by the PUSCH.

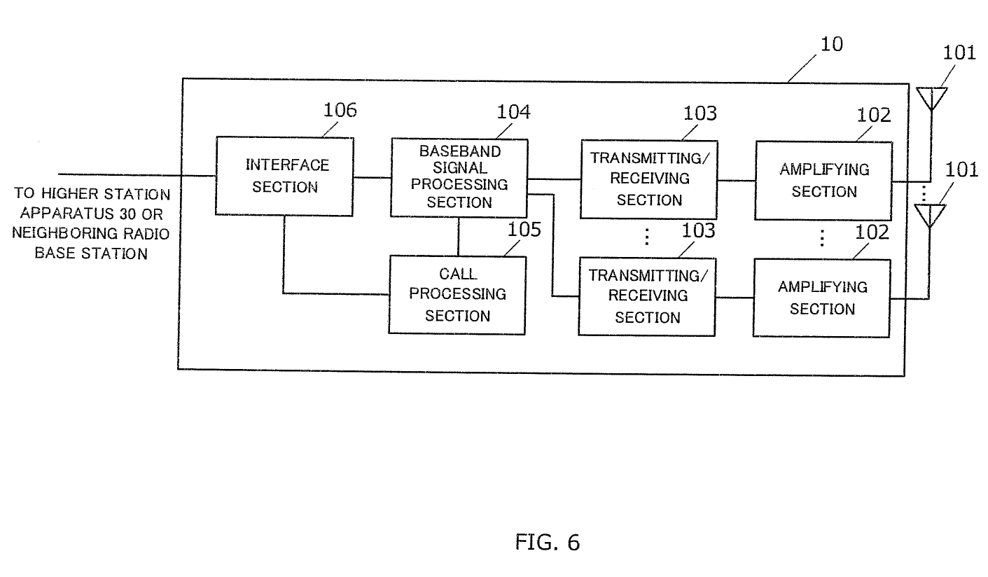

FIG. 6 is a diagram to show an overall structure of a radio base station 10 according to the present embodiment. As shown in FIG. 6, the radio base station 10 has a plurality of transmitting/receiving antennas 101 for MEMO (Multiple Input Multiple Output) communication, amplifying sections 102, transmitting/receiving sections (transmitting sections and receiving sections) 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, the user data is subjected to a PDCP (Packet Data Convergence Protocol) layer process, user data division and coupling, RLC (Radio Link Control) layer transmission processes such as an RLC retransmission control transmission process, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts the downlink signals, which are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

As for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, the X2 interface, etc.). Alternatively, the interface section 106 transmits and receives signals to and from the higher station apparatus 30 via a predetermined interface.

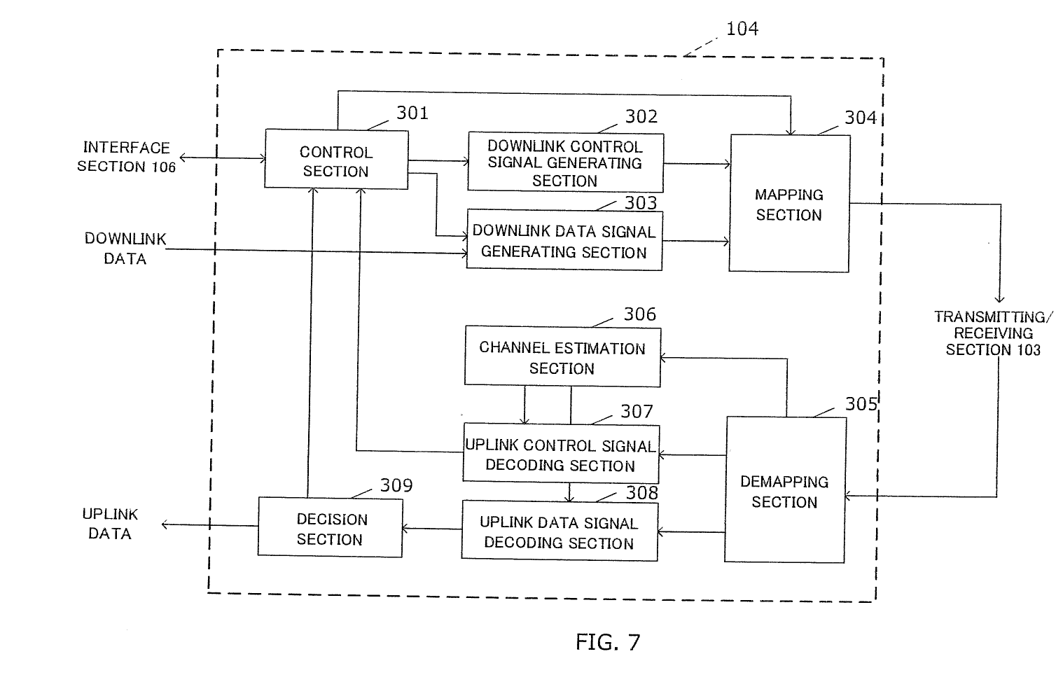

FIG. 7 is a diagram to show a principle functional structure of the baseband signal processing section 104 provided in the radio base station 10 according to the present embodiment. As shown in FIG. 7, the baseband signal processing section 104 provided in the radio base station 10 is comprised at least of a control section 301, a downlink control signal generating section 302, a downlink data signal generating section 303, a mapping section 304, a demapping section 305, a channel estimation section 306, an uplink control signal decoding section 307, an uplink data signal decoding section 308 and a decision section 309.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling of RA preambles communicated in the PRACH, uplink data that is communicated in the PUSCH, uplink control information that is communicated in the PUCCH or the PUSCH, and uplink reference signals (allocation control). Information about the allocation control of uplink signals (uplink control signals, uplink user data, etc.) is reported to the user terminals 20 by using a downlink control signal (DCI).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be used.

The downlink control signal generating section 302 generates downlink control signals (which may be both PDCCH signals and EPDCCH signals, or may be one of these) that are determined to be allocated by the control section 301. To be more specific, the downlink control signal generating section 302 generates downlink assignments, which report downlink signal allocation information, and uplink grants, which report uplink signal allocation information, based on commands from the control section 301. For the downlink control signal generating section 302, a signal generator or a signal generating circuit that can be described based on common understanding of the technical field to which the present invention pertains can be used.

The downlink data signal generating section 303 generates downlink data signals (PDSCH signals) that are determined to be allocated to resources by the control section 301. The data signals that are generated in the data signal generating section 303 are subjected to a coding process and a modulation process, based on coding rates and modulation schemes that are determined based on CSI from each user terminal 20 and so on.

The mapping section 304 controls the allocation of the downlink control signals generated in the downlink control signal generating section 302 and the downlink data signals generated in the downlink data signal generating section 303, to radio resources, based on commands from the control section 301. For the mapping section 304, a mapping circuit or a mapper that can be described based on common understanding of the technical field to which the present invention pertains can be used.

The demapping section 305 demaps the uplink signals transmitted from the user terminals 20 and separates the uplink signals. The channel estimation section 306 estimates channel states from the reference signals included in the received signals separated in the demapping section 305, and outputs the estimated channel states to the uplink control signal decoding section 307 and the uplink data signal decoding section 308.

The uplink control signal decoding section 307 decodes the feedback signals (delivery acknowledgement signals and/or the like) transmitted from the user terminals in the uplink control channel (PRACH, PUCCH, etc.), and outputs the results to the control section 301. The uplink data signal decoding section 308 decodes the uplink data signals transmitted from the user terminals through an uplink shared channel (PUSCH), and outputs the results to the decision section 309. The decision section 309 makes retransmission control decisions (A/N decisions) based on the decoding results in the uplink data signal decoding section 308, and outputs the results to the control section 301.

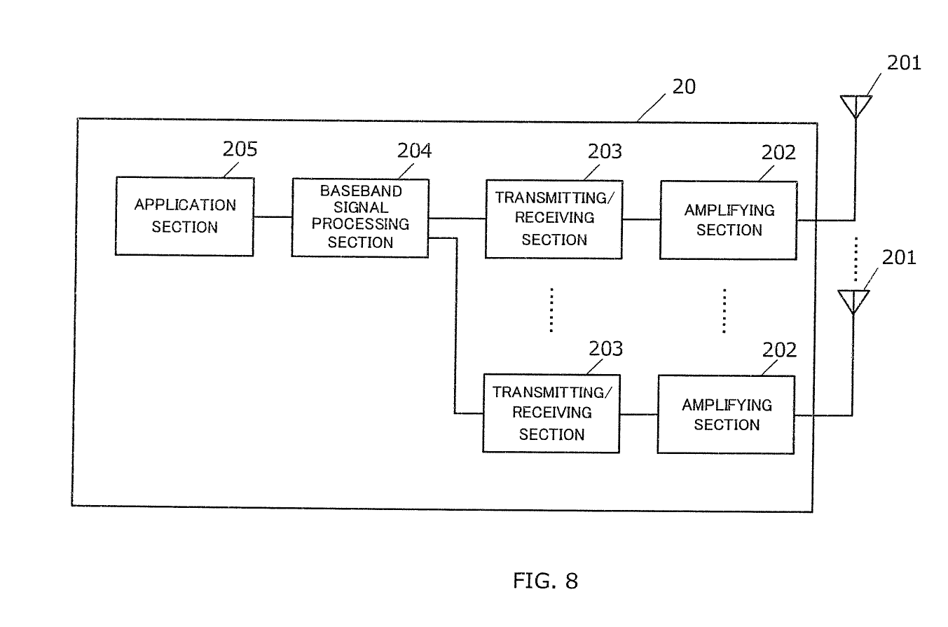

FIG. 8 is a diagram to show an overall structure of a user terminal 20 according to the present embodiment. As shown in FIG. 8, the user terminal 20 has a plurality of transmitting/receiving antennas 201 for MIMO communication, amplifying sections 202, transmitting/receiving sections (transmitting sections and receiving sections) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205. For the transmitting/receiving sections 203, transmitters/receivers, transmitting/receiving circuits or transmitting/receiving devices that can be described based on common understanding of the technical field to which the present invention pertains can be used.

Meanwhile, uplink user data is input from the application section 205 to the baseband signal processing section 204. In the baseband signal processing section 204, a retransmission control (HARQ) transmission process, channel coding, precoding, a discrete Fourier transform (DFT) process, an inverse fast Fourier transform (IFFT) process and so on are performed, and the result is forwarded to transmitting/receiving section 203. The baseband signal that is output from the baseband signal processing section 204 is converted into a radio frequency band in the transmitting/receiving sections 203. After that, the amplifying sections 202 amplify the radio frequency signals having been subjected to frequency conversion, and transmit the resulting signals from the transmitting/receiving antennas 201.

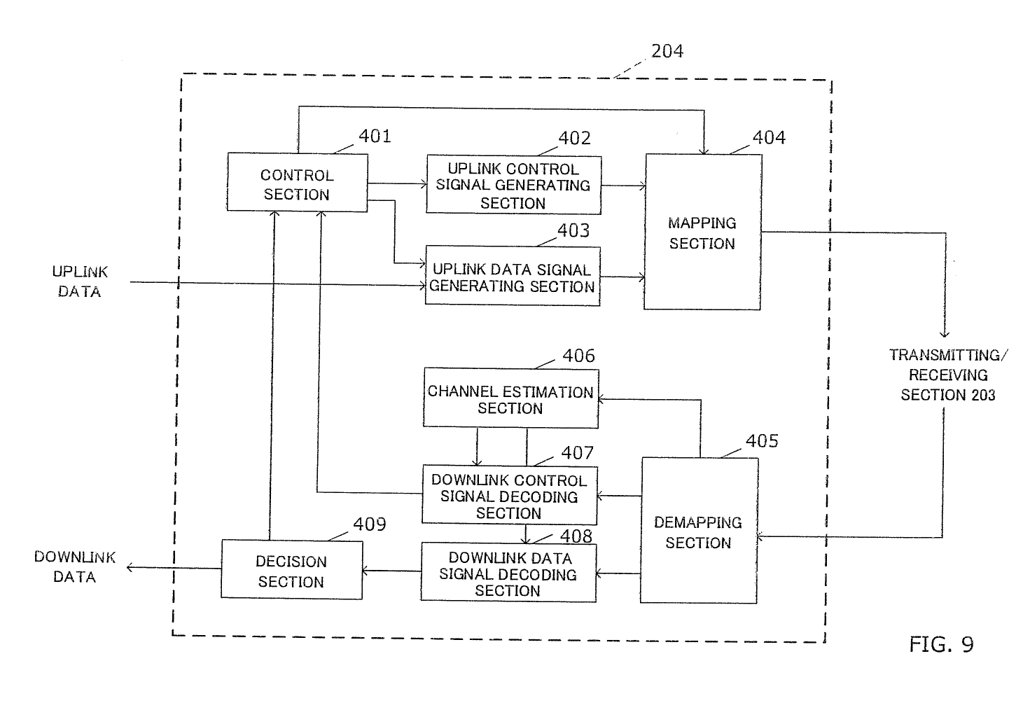

FIG. 9 is a diagram to show a principle functional structure of the baseband signal processing section 204 provided in the user terminal 20. As shown in FIG. 9, the baseband signal processing section 204 provided in the user terminal 20 is comprised at least of a control section 401, an uplink control signal generating section 402, an uplink data signal generating section 403, a mapping section 404, a demapping section 405, a channel estimation section 406, a downlink control signal decoding section 407, a downlink data signal decoding section 408 and a decision section 409.

The control section 401 controls the generation of uplink control signals (A/N signals, etc.), uplink data signals and so on, based on the downlink control signals (PDCCH signals) transmitted from the radio base stations 10, retransmission control decisions in response to the PDSCH signals received, and so on. The downlink control signals received from the radio base stations are output from the downlink control signal decoding section 408, and the retransmission control decisions are output from the decision section 409. For the control section 401, a controller, a control circuit or a control device that can be described based on common understanding of the technical field to which the present invention pertains can be used.

The control section 401 controls the transmission and receipt of signals in the licensed band or the unlicensed band. The control section 401 executes LBT at an OFDM symbol timing in a subframe of the unlicensed band, and, if the received power in the LBT period is equal to or lower than a threshold and no LAA downlink signal is detected, the control section 401 finds out that subframe is not used to transmit a downlink signal. The control section 401, upon detecting that the unlicensed band subframe is not used to transmit a downlink signal, may control an uplink signal to be transmitted in this subframe. Then, the control section 401 may apply control so that transmission of the uplink signal is started at the top of the subframe or in the middle of the subframe based on the result of LBT, and finished a predetermined period later (see FIG. 13).

The uplink control signal generating section 402 generates uplink control signals (feedback signals such as delivery acknowledgement signals, channel state information (CSI) and so on) based on commands from the control section 401. The uplink data signal generating section 403 generates uplink data signals based on commands from the control section 401. Note that, when an uplink grant is contained in a downlink control signal reported from a radio base station, the control section 401 commands the uplink data signal 403 to generate an uplink data signal. For the uplink control signal generating section 402, a signal generator or a signal generating circuit that can be described based on common understanding of the technical field to which the present invention pertains can be used.

The mapping section 404 controls the allocation of the uplink control signals (delivery acknowledgment signals and so on) and the uplink data signals to radio resources (PUCCH, PUSCH, etc.) based on commands from the control section 401.

The demapping section 405 demaps the downlink signals transmitted from the radio base station 10 and separates the downlink signals. The channel estimation section 407 estimates channel states from the reference signals included in the received signals separated in the demapping section 406, and outputs the estimated channel states to the downlink control signal decoding section 407 and the downlink data signal decoding section 408.

The downlink control signal decoding section 407 decodes the downlink control signals (PDCCH signals) transmitted in the downlink control channel (PDCCH), and outputs the scheduling information (information regarding the allocation to uplink resources) to the control section 401. Also, when information related to the cell to feed back delivery acknowledgement signals or information as to whether or not to apply RF tuning is included in the downlink control signals, these pieces of information are also output to the control section 401.

The downlink data signal decoding section 408 decodes the downlink data signals transmitted in the downlink shared channel (PDSCH), and outputs the results to the decision section 409. The decision section 409 makes retransmission control decisions (A/N decisions) based on the decoding results in the downlink data signal decoding section 408, and outputs the results to the control section 401.

Note that the present invention is by no means limited to the above embodiments and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosures of Japanese Patent Application No. 2014-226126, filed on Nov. 6, 2014, Japanese Patent Application No. 2015-009785, filed on Jan. 21, 2015, and Japanese Patent Application No. 2015-159943, filed on Aug. 13, 2015, including the specifications, drawings and abstracts, are incorporated herein by reference in their entirety.

1. A user terminal comprising:
a control section that controls transmission of an uplink signal in a first frequency carrier by executing LBT (Listen Before Talk); and
a transmitting/receiving section that receives a downlink signal that is transmitted from a radio base station in the first frequency carrier,
wherein the control section executes LBT at an OFDM symbol timing in a subframe of the first frequency carrier, and, if the received power in the LBT period is equal to or lower than a predetermined threshold and the downlink signal is not detected, the control section detects that the subframe is not used to transmit the downlink signal, and controls the uplink signal to be transmitted in this subframe.

2. The user terminal according to claim 1, wherein, based on the result of LBT, the control section controls the transmission of the uplink signal to be started at the top of the subframe or in the middle of the subframe, and finished a predetermined period later.

3. The user terminal according to claim 1, wherein, when an uplink grant is received in the transmitting/receiving section, the control section executes LBT in a subframe that is allocated by the uplink grant.

4. The user terminal according to claim 1, wherein:
the transmitting/receiving section receives, from the radio base station, at least one of a configuration as to whether or not uplink transmission is possible, a report of a timer that allows uplink transmission for a predetermined period of time, a report of a backoff time, and a modulation and coding scheme or a rank indicator that is available for use; and
the control section:
controls whether or not the uplink signal is transmitted, based on the configuration as to whether or not uplink transmission is possible;
controls, based on the timer, the uplink signal not to be transmitted when the timer that is set on the timer expires;
controls the time to execute LBT based on the backoff time; and
controls the uplink signal to be transmitted by using the modulation and coding scheme or the rank indicator.

5. The user terminal according to claim 1, wherein the control section controls the uplink signal to be transmitted by using a modulation and coding scheme or a rank indicator that is autonomously selected, or the number of resource blocks, and controls information about the modulation and coding scheme or the rank indicator, or about the number of resource blocks, to be reported to the radio base station in a specific resource.

6. The user terminal according to claim 5, wherein:
when the information about the modulation and coding scheme or the rank indicator, or about the number of resource blocks, is reported to the radio base station, the control section applies control so that a transmission method for a physical uplink control channel is used; and
the transmission method comprises at least one of use of a specific resource block that is configured in advance, intra-subframe hopping, and code division multiplex.

7. The user terminal according to claim 6, wherein the control section includes terminal ID information in the information.

8. The user terminal according to claim 1, wherein:
the transmitting/receiving section receives report of subsets of resources from the radio base station; and
the control section executes LBT for each subset band, and, when detecting that a subset is not used to transmit the downlink signal, controls the uplink signal to be transmitted in this subset.

9. The user terminal according to claim 1, wherein:
the transmitting/receiving section receives, from the radio base station, a report to make part of subframes of the first frequency carrier fixed for use on downlink or fixed for use on uplink; and
the control section applies control, based on the report, so that downlink signals are transmitted in the downlink-fixed subframes and uplink signals are transmitted in the uplink-fixed subframes.

10. A radio communication system comprising a radio base station and a user terminal that communicate by using a first frequency carrier in which LBT (Listen Before Talk) is configured, wherein:
the user terminal comprises:
a control section that controls transmission of an uplink signal in a first frequency carrier by executing LBT; and
a transmitting/receiving section that receives a downlink signal that is transmitted from a radio base station in the first frequency carrier; and
the control section executes LBT at an OFDM symbol timing in a subframe of the first frequency carrier, and, if the received power in the LBT period is equal to or lower than a predetermined threshold and the downlink signal is not detected, the control section detects that the subframe is not used to transmit the downlink signal, and controls the uplink signal to be transmitted in this subframe.
